(19) United States
(12) Patent Application Publication
(10) Pub. No.: US 2014/0064827 A1
(43) Pub. Date: Mar. 6, 2014

(54) LOCKING ASSEMBLY FOR LOCKING AN AIRCRAFT INTERIOR STRUCTURE TO AN INTERNAL MOUNTING FRAME IN AN AIRCRAFT CABIN

(71) Applicant: Driessen Aerospace Group N.V., Alkmaar (NL)

(72) Inventors: Maarten Michiel Korenromp, Heerhugowaard (NL); Remko Schiphorst, Landsmeer (NL)

(21) Appl. No.: 14/015,057

(22) Filed: Aug. 30, 2013

(30) Foreign Application Priority Data
Aug. 30, 2012 (NL) 2009393

(51) Int. Cl. B64D 11/00; F16B 2/06

(52) U.S. Cl. CPC B64D 11/00; F16B 2/06
USPC 403/63

(57) ABSTRACT

The invention relates to a locking assembly for locking an aircraft interior structure (13) to an internal mounting frame (2) comprising: a sliding element (1) which is suitable for insertion in the internal mounting frame (2), a height adjustment assembly, comprising a lower and an upper height adjustment part (4, 5). The assembly further comprises a fitting (6) attachable to the aircraft interior structure, having a recess wherein a projection (19) of the upper height adjustment part (5) is received, wherein the fitting (6) can be moved with respect to the projection (19) in a plane defined by Xᵣ- and Yᵣ-directions. Further provided is a locking bolt (11) received in the upper height adjustment part (5) for locking the fixation element (9), the fitting (6), and the height adjustment parts (4, 5) to the sliding element (1).

### FIELD OF THE INVENTION

The invention relates to an assembly for locking an aircraft interior structure, such as a stowage, to an internal mounting frame, such as a seat track, in an aircraft cabin.

### BACKGROUND OF THE INVENTION

Such an assembly is known. Various methods and assemblies are known for securely locking an aircraft interior structure, such as a stowage, to an internal mounting frame of an aircraft cabin, such as a seat track. A known method is to first position a stowage with respect to a seat track with so-called shim plates, and then to fix the position of the stowage relative to the seat track. Fore mentioned positioning comprises the adjustment of the stowage with respect to the seat track in a Z-direction, i.e. a direction perpendicular to the floor in which the seat track is provided, and in X- and Y-directions, wherein the X-direction is parallel to the seat track and the Y-direction is perpendicular to the X and Z-directions. During positioning, shim plates are inserted between the stowage and the seat track in order to position the stowage with respect to the seat track.

However, a disadvantage of the known way of locking the aircraft structure to the internal mounting frame, is that during positioning, which is usually done manually by an aircraft mechanic, shim plates may get lost. The aircraft mechanic may e.g. accidentally drop a shim plate during installation, as a consequence of which the lost shim plate may enter a part of the aircraft cabin or another part of the aircraft where the shim plate may cause damage due to it being thrown around by subsequent aircraft movements during operation of the aircraft. Also, as it is not known beforehand how many shim plates or what size of shim plates are necessary, a plurality of shim plates needs to be available, of which only a portion may be used. Furthermore, the shim plates that have been inserted successfully between the aircraft interior structure and the internal mounting frame may loosen during the life span of the aircraft.

Therefore, it is an object of the invention to provide an improved locking assembly that allows three-dimensional positioning and fixation of the aircraft interior structure with respect to the internal mounting frame, without the need of shim plates.

### SUMMARY OF THE INVENTION

This object is achieved by providing a locking assembly for locking an aircraft interior structure, such as a stowage, to an internal mounting frame, such as a seat track, in an aircraft cabin, comprising:

a sliding element (1) which is suitable for insertion in the internal mounting frame (2), the sliding element (1) being slidable in the internal mounting frame in an Xₛ-direction, and being lockable to the internal mounting frame, a height adjustment assembly, comprising a lower and an upper height adjustment part (4, 5), the lower height adjustment part (4) being arranged on the sliding element (1) and being provided with a saw-toothed main tooth pattern (M), the upper height adjustment part (5) being provided with a similar main tooth pattern (M), wherein at least one of the height adjustment parts (4, 5) is provided with a sub-tooth pattern (S) superimposed on the main tooth pattern (M), the tooth patterns of both height adjustment parts engaging each other to allow adjustment of height in a Z-direction by moving the tooth patterns with respect to each other, a fitting (6) attachable to the aircraft interior structure by means of a locking bolt (11), having a recess wherein the locking bolt (11) can be received, wherein the fitting (6) can be moved with respect to the upper height adjustment part (5) in a plane defined by Xᵣ- and Yᵣ-directions, the plane being perpendicular to the Z-direction,

a fixation element (9) suitable for being arranged around the locking bolt (11) for fixing the position of the fitting (6) in the Xᵣ-direction with respect to the upper height adjustment part (5),

wherein the locking bolt (11) is received in the upper height adjustment part (5) for locking the fixation element (9), the fitting (6), and the height adjustment parts (4, 5) to the sliding element (1).

The sliding element allows adjustment of the aircraft interior structure in an Xₛ-direction, i.e. parallel to the internal mounting frame, the sliding element being lockable to the internal mounting frame by any appropriate means. The height adjustment assembly allows convenient adjustment in Z-direction, i.e. the direction pointing away from the internal mounting frame, due to the height adjustment assembly parts being movable, for instance being rotatable, with respect to each other via the tooth patterns. The fitting allows the position of the aircraft interior structure to be adjusted in a plane perpendicular to the Z-axis, i.e. in Xᵣ- and Yᵣ-directions. The fitting may be formed as a plate member. The locking bolt finally locks the locking assembly, thereby fixing the position of the aircraft interior structure with respect to the internal mounting frame. In this way, three-dimensional positioning of the aircraft interior structure with respect to the internal mounting frame is achieved, while the use of shim plates is no longer necessary. According to a further aspect there is provided a method for arranging a locking assembly according to any one of the claims 1-13 to an internal mounting frame (2) in an aircraft cabin, comprising the steps of:
positioning and locking the sliding element (1) with respect to the internal mounting frame (2), arranging the lower height adjustment part (4) on the sliding element (1),

arranging the upper height adjustment part (5) on the lower height adjustment part (4) with the tooth patterns (M, S) of both height adjustment parts (4, 5) engaging each other,

moving the upper and lower height adjustment parts (4, 5) with respect to each other to adjust the height of the upper height adjustment part (5) with respect to the sliding element (1) in the Z-direction,

arranging the recess of the fitting (6) on the upper height adjustment part (5),

adjusting the position of the fitting (6) in a plane defined by an Xᵣ-direction and a Yᵣ-direction, the plane being perpendicular to the Z-direction, arranging a fixation element (9) on the fitting (6) for fixing the position of the fitting (6) with respect to the upper height adjustment part (5) in the Xᵣ-direction,

arranging a locking bolt (11) in the upper height adjustment part (5) in the Z-direction, and

locking the locking bolt (11) to the sliding element (1) such that the fixation element (9), the fitting (6), and the height adjustment parts (4, 5) are locked to the sliding element (1).

Positioning and locking the sliding element may comprise sliding the sliding element towards its desired position in the internal mounting frame in an Xs-direction and locking the sliding element in the internal mounting frame by using appropriate locking means.

### BRIEF DESCRIPTION OF THE DRAWINGS

An embodiment of a locking assembly according to the invention will by way of non-limiting example be described in detail with reference to the accompanying drawings. In the drawings:

FIG. 1 shows an aircraft cabin provided with a stowage arranged on the seat tracks of the cabin,

FIG. 2 shows an exploded view of a locking assembly according to the invention,

FIG. 3a shows a perspective view of the height adjustment assembly used in the locking assembly in a first state,

FIG. 3b shows the height adjustment assembly of FIG. 3a in a second state,

FIG. 4 shows the adjustment of the fitting in the form of a serrated plate in Xᵣ-direction,

FIG. 5 shows the adjustment of the fitting in Yᵣ-direction,

FIG. 6a shows a detailed view of the mounting of the lower adjustment bushing on the seat track block,

FIG. 6b shows the lower adjustment bushing being mounted on the seat track block 1 shown in FIG. 6a,

FIG. 7 shows an alternative embodiment of the locking assembly according to the invention,

FIG. 8 shows the assembled locking assembly of FIG. 8, and

FIG. 9 shows a cut-away view of a stowage arranged on the seat track via the locking assembly according to the invention.

### DETAILED DESCRIPTION OF THE INVENTION

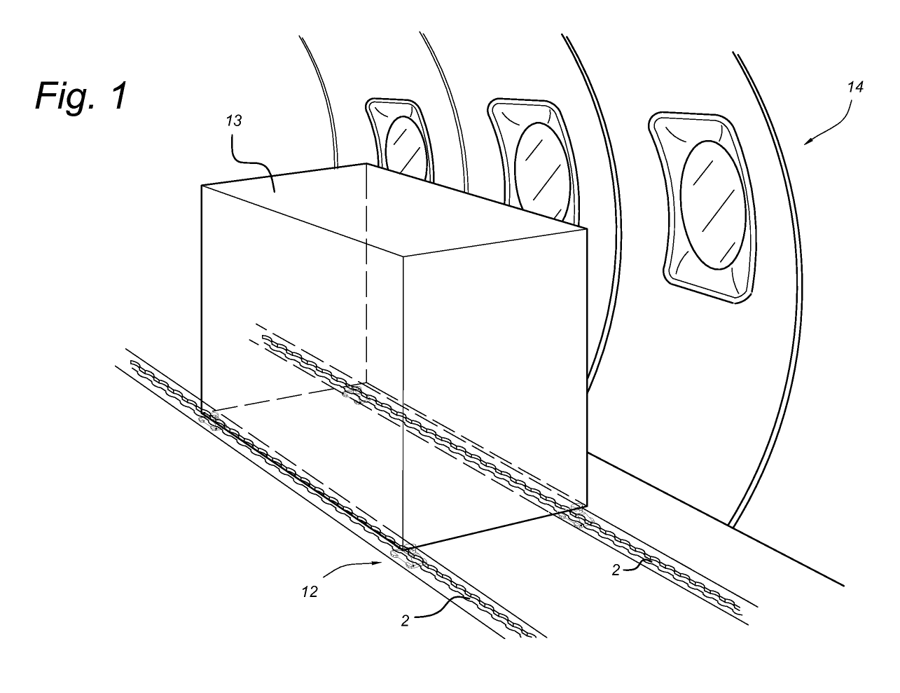

FIG. 1 schematically shows an aircraft cabin 14 provided with an aircraft interior structure in the form of a stowage 13 arranged on an internal mounting frame embodied by a pair of seat tracks 2 of the cabin 14. The locking assemblies for locking the stowage 13 to the seat tracks 2 are indicated with the reference numeral 12. In this case four individual locking assemblies 12 are provided near the lower corners of the stowage 13. Depending on the type of interior structure to be locked to the internal mounting frame a different number and/or configurations of locking assemblies is/are conceivable.

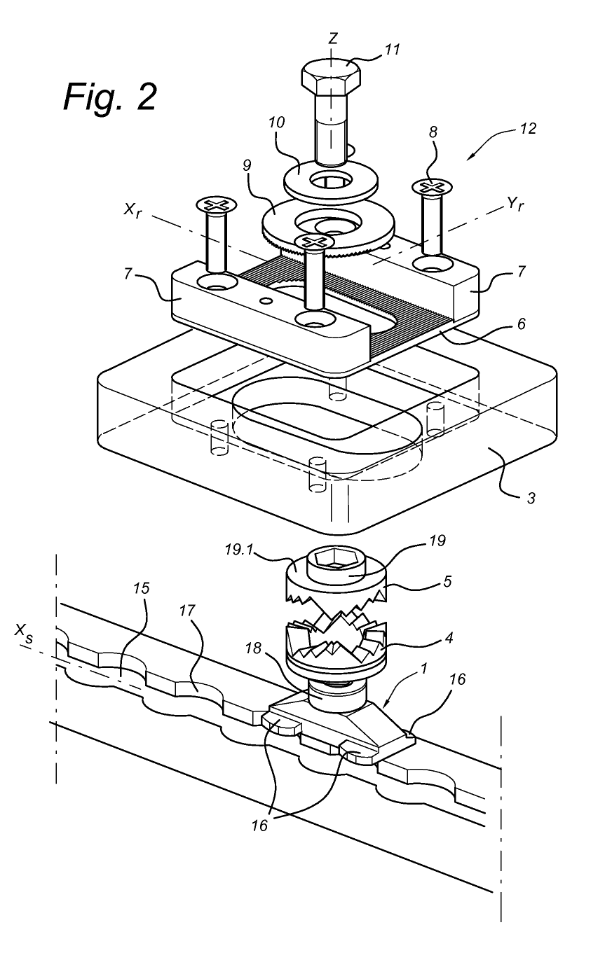

FIG. 2 shows an exploded view of a locking assembly 12 according to an embodiment. FIG. 2 will be discussed from bottom to top, corresponding to the sequence of assembly. The seat track 2 as shown has an elongated groove 15, defining an Xₛ-direction, in which a sliding element in the form of a seat track block 1 can be moved in a sliding fashion. The groove 15 is widened at predetermined intervals (widening 17) along the groove 15 in order to allow the vertical insertion of the seat track block 1 into the seat track 2. The seat track block 1 is provided with two pairs of relatively small support feet 16 on which the seat track block 1 is allowed to slide in the Xₛ-direction. The distance between the pairs of support feet 16 is so chosen as to allow the feet 16 to be vertically inserted in the groove 15 via the groove widenings 17. After the seat track block 1 has been slid to the desired position, it can be locked in that position by appropriate locking means (this will be discussed later). The seat track block 1 has two inclined ends to facilitate easy sliding in the groove 15.

On top of the seat track block 1 a cylindrical portion 18, projecting in a Z-direction away from the floor, is shown, whereon a height adjustment assembly 4, 5 comprising two height adjustment parts 4, 5 (embodied by crown wheels) is to be positioned. The inside of the cylindrical portion 18 is hollow and is provided with a screw thread. The lower height adjustment part 4, hereafter to be denoted as “lower adjustment bushing” 4, is provided with a saw-toothed main tooth pattern, consisting of four main teeth in this example, and a saw-toothed sub-tooth pattern superimposed on the main tooth pattern. The sub-tooth pattern is superimposed on one side of the main teeth. The teeth of the sub-tooth pattern are smaller than the teeth of the main tooth pattern. An upper adjustment part 5, hereafter: “upper adjustment bushing” 5, is placed on top of the lower adjustment bushing 4.

The upper adjustment bushing 5 is provided with a similar main tooth pattern as the lower adjustment bushing 4, matching the tooth pattern of the lower adjustment bushing 4. As shown, the upper adjustment bushing 5 also comprises a saw-toothed sub-toothed pattern.

Both tooth patterns engage each other, the tooth pattern of the upper adjustment bushing 5 being supported by the tooth pattern of the lower adjustment bushing 4. The tooth patterns allow the bushing parts 4, 5 to be rotated with over each other, causing the upper bushing 5 to be height-adjustable in Z-direction with respect to the lower adjustment bushing 4 and the seat track block 1. Preferably, the height difference between adjacent teeth of the sub-tooth pattern is approximately 1 mm, allowing the height of the upper adjustment bushing 5 to be adapted in steps of 1 mm

It is conceivable that only one of the lower and upper adjustment bushings 4, 5 has a sub-toothed pattern.

The upper adjustment bushing 5 is provided with a projection in the form of a cylindrical part 19, projecting away from the floor in Z-direction, on top of it. The upper adjustment bushing 5 comprises a carrier surface 19.1 surrounding the projection to carry a fitting as will be explained in more detail below.

A bottom panel insert 3, attached to the to-be-fitted stowage, is subsequently arranged on top of the upper adjustment bushing 5. In a space provided on the top side of that panel insert 3 a fitting in the form of a serrated plate 6 is received which is provided with a longitudinal recess 20 that receives the cylindrical part 19 of the upper bushing 5 and allows that recess 20 to slide around the part 19, much like a spline-and-groove configuration, the fitting resting on the carrier surface 19.1. The longitudinal direction of the recess 20 defines an Xᵣ-direction, whereas an Yᵣ-direction is defined being perpendicular to both the Xᵣ and Z-directions. The serrated plate 6 is provided with filler blocks 7 arranged on two of its sides. The filler blocks 7 are provided with holes wherein screws 8 are to be arranged for securely mounting the serrated plate 6 to the bottom panel insert 3, such that the serrated plate 6 and the bottom insert 3 can be adjusted simultaneously. The dimensions of the recess 20 are so chosen as to allow sliding of the projecting part 19 in the longitudinal direction of the recess 20 (i.e. in Xᵣ direction), but also, to a lesser extent, in a direction perpendicular to the longitudinal direction of the recess 20, i.e. in Yᵣ-direction. Preferably, the adjustment range in Xᵣ direction is 10-20 mm, more preferably 12-16 mm, most preferably around 14 mm The adjustment range in the Xᵣ-direction is preferably at least equal to the distance between the widenings 17 in the seat track 2. In Yᵣ-direction, the adjustment range is preferably 1-2 mm, more preferably 1.5 mm

After adjustment in the Xᵣ-direction, the position of the serrated plate 6 in that direction can be fixated by means of a serrated washer 9 arranged on top of the serrated plate 6. The serrations of the serrated washer 9 thereto engage the serrations of the serrated plate 6. The serrations of both the serrated plate 6 and the serrated washer 9 preferably run parallel to the Yᵣ-direction. The serrated washer 9 has an elongated central opening, the function of which is explained below.

Another washer 10 is then arranged on top of the serrated washer 9. Subsequently, a locking bolt 11 is inserted into the hole of the washer 10, the hole of the serrated washer 9, the recess 20 and the bushings 4, 5 to finally engage the screw thread of the cylindrical portion 18 of the seat track block 1, after which the bolt is tightened. Consequently, the stowage is firmly locked to the seat track 2.

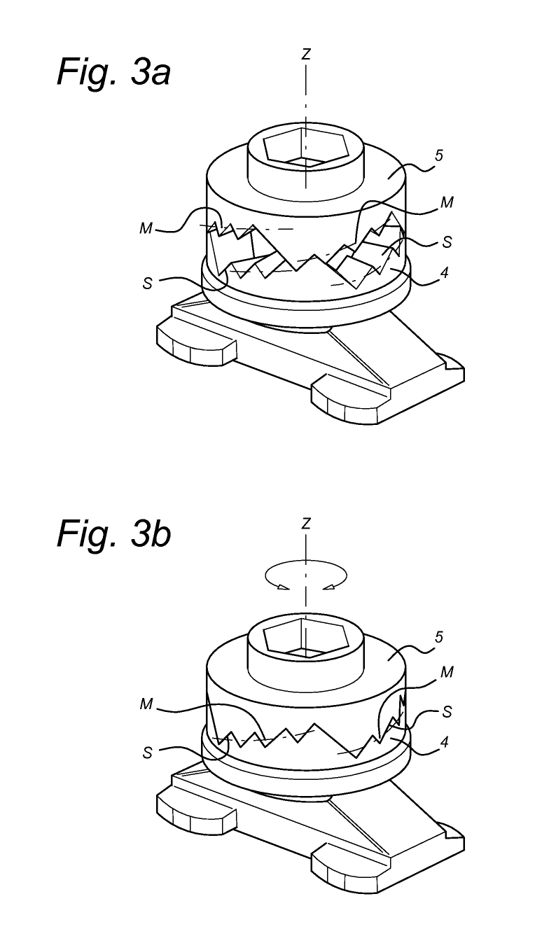

FIG. 3a shows a perspective view of the adjustment bushings 4, 5 as used in the locking assembly 12 in a first state. The lower adjustment bushing 4 and the upper adjustment bushing 5 are shown both comprising a main tooth pattern M, indicated by dashed lines, and sub-tooth patterns S superimposed on the main tooth patterns M. FIG. 3a shows a first state in which the upper adjustment bushing 5 is maximally elevated (in Z-direction) with respect to the lower adjustment bushing 4. The position shown is the highest position possible.

FIG. 3b shows the height adjustment assembly 4, 5 of FIG. 3a in a second state, wherein the upper adjustment bushing 5 is minimally elevated with respect to the lower adjustment bushing 4.

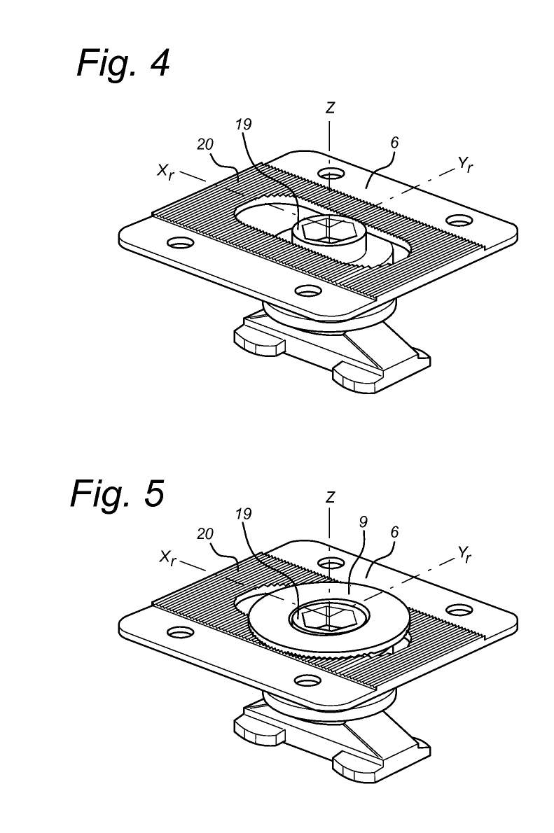

FIG. 4 shows the adjustment of the fitting in the form of the serrated plate 6 in Xᵣ-direction, wherein the recess 20 is slid around the upper cylindrical portion 19 to bring about the adjustment in Xᵣ-direction.

FIG. 5 shows the adjustment of the fitting in Yᵣ-direction. Thereto, the serrated washer 9 is arranged on the serrated plate 6 in order to fixate the Xᵣ-position. Subsequently, the cylindrical portion 19 is allowed to move around along the longitudinal axis of the elongated opening of the serrated washer 9 to bring about adjustment in Yᵣ-direction. The elongated opening of the serrated washer 9 has a width (smallest dimension) which matches the outer dimension of projecting part 19 in the Xᵣ-direction and a length which is larger than the outer dimension of projection part 19 to allow movement in the Yᵣ-direction.

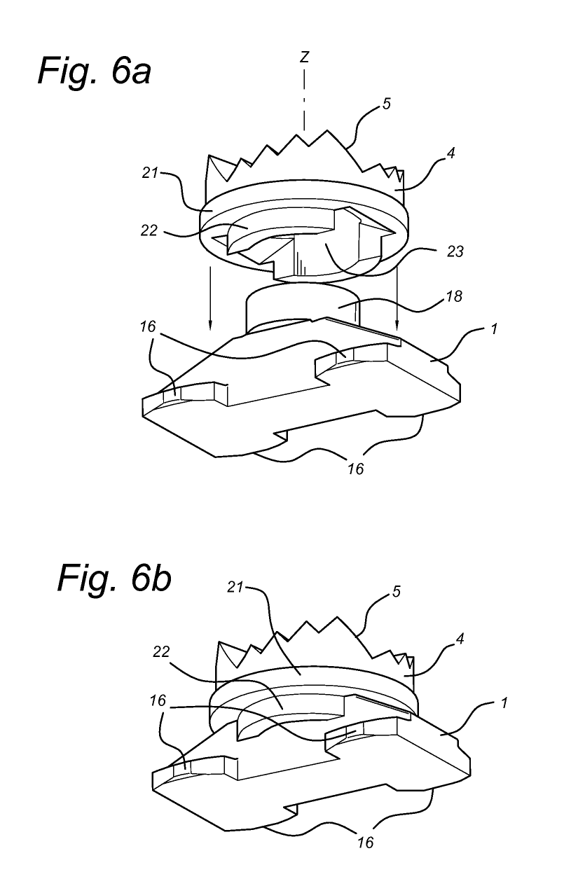

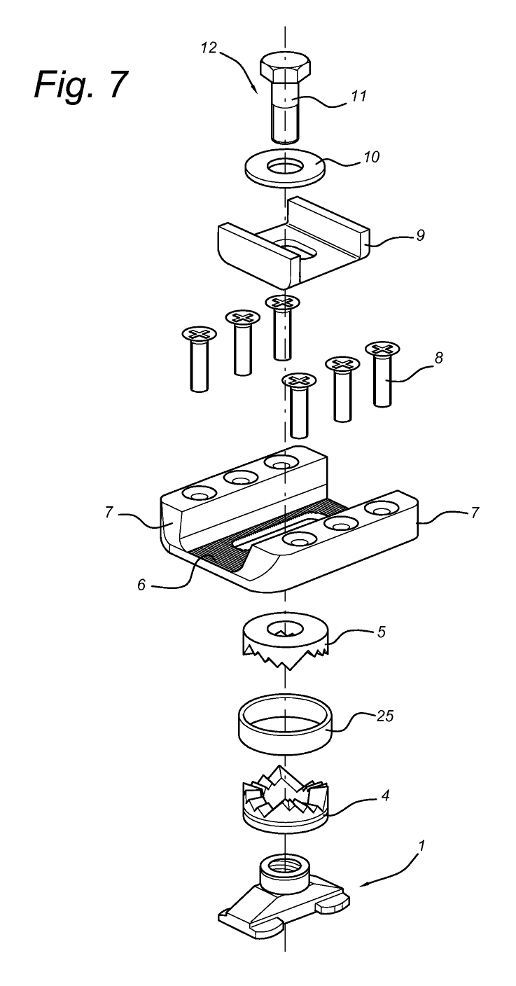

FIG. 6a shows a detailed view of the mounting of the lower adjustment bushing 4 on the seat track block 1. In this view, the construction of the underside of the lower adjustment bushing 4 can be more easily seen. The underside of the lower adjustment bushing 4 is provided with two fixation arches 22 which prevent the lower adjustment bushing 4 from rotating with respect to the seat track block 1 when these arches 22 are aligned with the seat track block 1. Furthermore, the underside is provided with an additional cut-away groove 23 to bring about that the arches 22 can be positioned so low as to allow positioning of the arches near the sides of the seat track block 1 to prevent rotation of the lower adjustment bushing 4. When the fixation arches 22 are rotated essentially in a direction perpendicular to the sliding direction of the seat track block 1, ending up to be supported on the seat track block 1, they can be used to lock the lower adjustment bushing 4 and the seat track block 1 in the seat track.

FIG. 6b shows the lower adjustment bushing 4 being mounted on the seat track block 1 shown in FIG. 6a. The fixation arches 22 are aligned with the seat track block 1 to prevent rotation of the lower adjustment bushing 4 with respect to the seat track block 1.

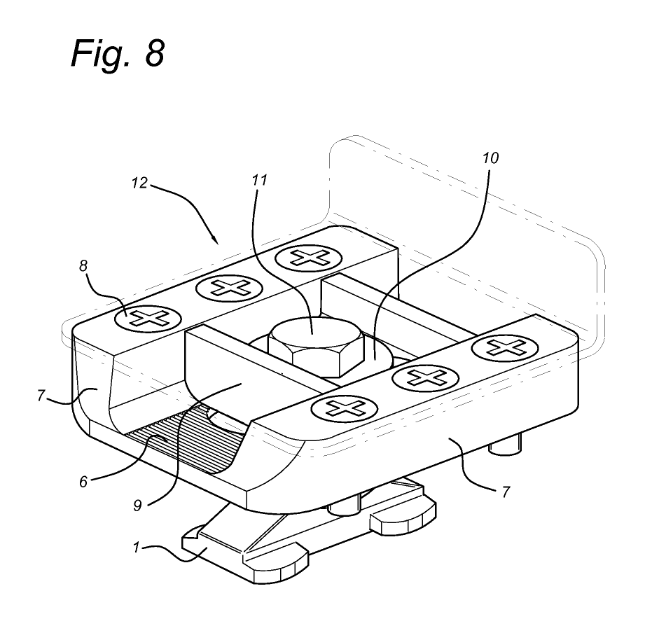

Alternative embodiments can be conceived. The embodiment described above may for instance also be embodied with an upper adjustment bushing 5 without the projection in the form of a cylindrical part 19, projecting away from the floor in Z-direction, on top of it. According to such an embodiment, the locking bolt 11 is directly received in the recess of fitting 6. A different embodiment without part 19 will be described below with reference to FIGS. 7 and 8.

FIG. 7 shows an alternative embodiment of the locking assembly 12 according to the invention. With respect to the embodiment as shown in FIGS. 1-6, the upper adjustment bushing 5 now has a flat top surface and the serrated washer 9 has a substantially square or rectangular shape when seen in top view. This embodiment further comprises additional, optional, differences. It comprises two opposing side flanges, wherein the flanges are directed in upward direction, such that a U-shaped cross-section is achieved. Preferably, a covering ring 25 is arranged around the upper and lower adjustment bushings 4, 5.

FIG. 8 shows the assembled locking assembly 12 of FIG. 7. It can be seen that the side flanges of the serrated washer 9 conveniently form an enclosure together with the filler blocks 7 for containing the head of the locking bolt 11.

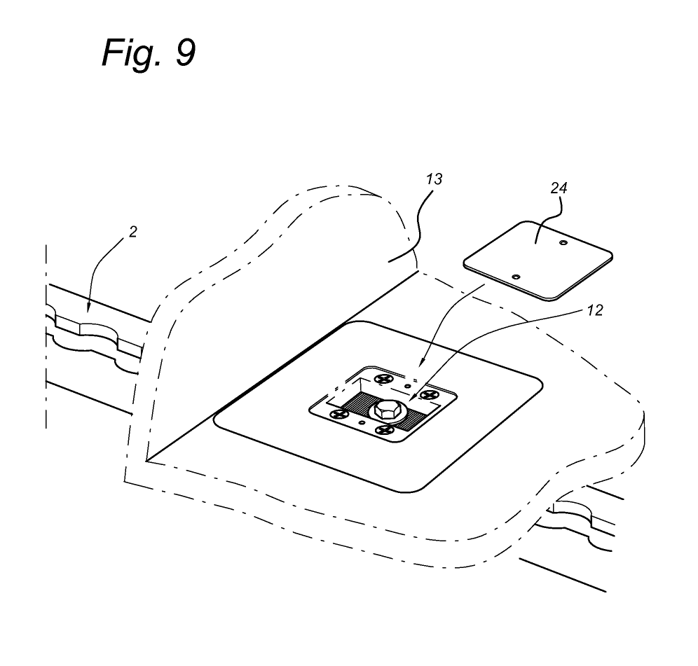

FIG. 9 shows a cut-away view of a stowage 13 arranged on the seat track 1 via the locking assembly 12 according to the invention. FIG. 9 shows the stowage 13 being fixed to the seat track block 1 and the seat track before a cover plate 24 is placed over the assembly 12.

Based on the above there is thus provided a locking assembly for locking an aircraft interior structure 13, such as a stowage, to an internal mounting frame 2, such as a seat track, in an aircraft cabin, comprising:

a sliding element 1 which is suitable for insertion in the internal mounting frame 2, the sliding element 1 being slidable in the internal mounting frame in an Xₛ-direction, and being lockable to the internal mounting frame,

a height adjustment assembly, comprising a lower and an upper height adjustment part 4, 5, the lower height adjustment part 4 being arranged on the sliding element 1 and being provided with a saw-toothed main tooth pattern M, the upper height adjustment part 5 being provided with a similar main tooth pattern M, wherein at least one of the height adjustment parts 4, 5 is provided with a sub-tooth pattern S superimposed on the main tooth pattern M, the tooth patterns of both height adjustment parts engaging each other to allow adjustment of height in a Z-direction by moving the tooth patterns with respect to each other, wherein the upper height adjustment part 5 has a projection 19 projecting away from the sliding element 1 in Z-direction,

a fitting 6 attachable to the aircraft interior structure, having a recess wherein the projection 19 of the upper height adjustment part 5 is received, wherein the fitting 6 can be moved with respect to the projection 19 in a plane defined by Xᵣ- and Yᵣ-directions, the plane being perpendicular to the Z-direction,

a fixation element 9 arranged around the projection 19 for fixing the position of the fitting 6 in the Xᵣ-direction with respect to the upper height adjustment part 5,

a locking bolt 11 received in the upper height adjustment part 5 for locking the fixation element 9, the fitting 6, and the height adjustment parts 4, 5 to the sliding element 1.

Thus, the invention has been described by reference to the embodiments discussed above. It will be recognized that these embodiments are susceptible to various modifications and alternative forms well known to those of skill in the art without departing from the spirit and scope of the invention. Accordingly, although specific embodiments have been described, this were examples only and is not limiting upon the scope of the invention.

### REFERENCE NUMERALS

1. Seat track block
2. Seat track
3. Bottom panel insert
4. Lower adjustment bushing
5. Upper adjustment bushing
6. Serrated plate
7. Filler block
8. Screws
9. Serrated washer
10. Washer
11. Locking bolt
12. Locking assembly
13. Stowage
14. Aircraft cabin
15. Groove
16. Support foot
17. Groove widening
18. Projecting cylindrical portion
19. Projecting part upper bushing
20. Longitudinal recess
21. Lower adjustment bushing flange
22. Fixation arch
23. Cut-away groove
24. Cover plate
25. Covering ring

1. Locking assembly for locking an aircraft interior structure (13), such as a stowage, to an internal mounting frame (2), such as a seat track, in an aircraft cabin, comprising:
a sliding element (1) which is suitable for insertion in the internal mounting frame (2), the sliding element (1) being slidable in the internal mounting frame in an Xₛ-direction, and being lockable to the internal mounting frame,
a height adjustment assembly, comprising a lower and an upper height adjustment part (4, 5), the lower height adjustment part (4) being arranged on the sliding element (1) and being provided with a saw-toothed main tooth pattern (M), the upper height adjustment part (5) being provided with a similar main tooth pattern (M), wherein at least one of the height adjustment parts (4, 5) is provided with a sub-tooth pattern (S) superimposed on the main tooth pattern (M), the tooth patterns of both height adjustment parts engaging each other to allow adjustment of height in a Z-direction by moving the tooth patterns with respect to each other, a fitting (6) attachable to the aircraft interior structure by means of a locking bolt (11), having a recess wherein the locking bolt (11) can be received, wherein the fitting (6) can be moved with respect to the upper height adjustment part (5) in a plane defined by Xᵣ- and Yᵣ-directions, the plane being perpendicular to the Z-direction,
a fixation element (9) suitable for being arranged around the locking bolt (11) for fixing the position of the fitting (6) in the Xᵣ-direction with respect to the upper height adjustment part (5),
wherein the locking bolt (11) is received in the upper height adjustment part (5) for locking the fixation element (9), the fitting (6), and the height adjustment parts (4, 5) to the sliding element (1).

2. Locking assembly according to claim 1, wherein the upper height adjustment part (5) has a projection (19) projecting away from the sliding element (1) in Z-direction, wherein the projection (19) is received in the recess and receives the locking bolt (11), and the fitting (6) is arranged around the recess, wherein the fitting (6) can be moved with respect to the projection (19) in a plane defined by Xᵣ- and Yᵣ-directions, the plane being perpendicular to the Z-direction, wherein the fixation element (9) is arranged around the locking bolt (11) for fixing the position of the fitting (6) in the Xᵣ-direction with respect to the upper height adjustment part (5).

3. Locking assembly according to claim 1, wherein the recess in the fitting (6) has a longitudinal shape aligned with the Xᵣ-direction allowing the fitting (6) to move in the Xr-direction, the longitudinal rₑcess haᵥing dimensions in Yᵣ-direction, the Yᵣ-direction being perpendicular to the Xᵣ- and Z-directions, to allow movement of the fitting in the Yᵣ-direction.

4. Locking assembly according to claim 1, wherein the lower and upper height adjustment parts (4, 5) are crown wheels and the tooth patterns (M, S) of the height adjustment parts allow adjustment of height in the Z-direction by rotation of the tooth patterns (M, S) with respect to each other about a rotational axis running through the crown wheels and aligned with the Z-direction.

5. Locking assembly according to claim 1, wherein the fitting (6) comprises a serrated plate having serrations extending in Yᵣ-direction and the fixation element (9) comprises a serrated washer for grabbing the serrations of the serrated plate of the fitting (6) for fixing the position of the fitting (6) in the Xᵣ-direction.

6. Locking assembly according to claim 1, wherein the fixation element (9) comprises a longitudinal recess (20) allowing movement of the fixation element (9) and the fitting (6) with respect to the locking bolt (11) or the projection (19) in Yᵣ-direction.

7. Locking assembly according to claim 1, wherein the sliding element (1) can be locked to the internal mounting frame (2) by the lower height adjustment part (4).

8. Locking assembly according to claim 7, wherein the lower height adjustment part (4) comprises a sideways projection on the toothless side of the lower height adjustment part (4) that engages the seat track (2) when the lower height adjustment part (4) is rotated about an axis of rotation aligned with the Z-direction in a first orientation to engage the internal mounting frame (2), and disengages the internal mounting frame (2) when it is rotated to a second orientation.

9. Locking assembly according to claim 7, wherein the angular difference between the first and second orientations is 90°.

10. Locking assembly according to claim 1, wherein the main tooth pattern (M) is formed by alternating upwardly and downwardly inclined surfaces and the sub-tooth pattern (S) is superimposed on the upwardly inclined surfaces of at least one of the height adjustment parts (4, 5).

11. Locking assembly according to claim 1, wherein both the height adjustment parts (4, 5) comprise a main tooth pattern (M) and a super-imposed sub-tooth pattern (S) which are formed in such a way that the patterns of the upper and lower height adjustment parts (4, 5) fully engage each other in a lowest height position.

12. Locking assembly according to claim 1, wherein the main tooth pattern (M) on one of the height adjustment parts (4, 5) comprises four evenly distributed teeth.

13. Locking assembly according to claim 1, wherein a tooth height of the sub-tooth pattern (S) differs by 1 mm for adjacent sub-teeth.

14. Aircraft cabin provided with a locking assembly according to claim 1.

15. Method for arranging a locking assembly according to claim 1 to an internal mounting frame (2) in an aircraft cabin, comprising the steps of:
positioning and locking the sliding element (1) with respect to the internal mounting frame (2), arranging the lower height adjustment part (4) on the sliding element (1),
arranging the upper height adjustment part (5) on the lower height adjustment part (4) with the tooth patterns (M, S) of both height adjustment parts (4, 5) engaging each other,
moving the upper and lower height adjustment parts (4, 5) with respect to each other to adjust the height of the upper height adjustment part (5) with respect to the sliding element (1) in the Z-direction,
arranging the recess of the fitting (6) on the upper height adjustment part (5),
adjusting the position of the fitting (6) in a plane defined by an Xᵣ-direction and a Yᵣ-direction, the plane being perpendicular to the Z-direction,
arranging a fixation element (9) on the fitting (6) for fixing the position of the fitting (6) with respect to the upper height adjustment part (5) in the Xᵣ-direction,
arranging a locking bolt (11) in the upper height adjustment part (5) in the Z-direction, and
locking the locking bolt (11) to the sliding element (1) such that the fixation element (9), the fitting (6), and the height adjustment parts (4, 5) are locked to the sliding element (1).

16. Method according to claim 15, wherein the upper height adjustment part (5) comprises a projection (19) projecting away from the sliding element (1) in Z-direction, the projection (19) being received in the recess of the fitting (6), wherein the fixation element (9) is arranged around the projection (19) for fixing the position of the fitting (6) with respect to the upper height adjustment part (5) in the Xᵣ-direction.

17. Method according to claim 15, wherein the upper and lower height adjustment parts (4, 5) are crown wheels and moving the upper and lower height adjustment parts (4, 5) with respect to each other comprises rotating the tooth patterns (M, S) with respect to each other about a rotational axis aligned with the Z-direction.
